(19) United States
(12) Patent Application Publication
(10) Pub. No.: US 2009/0088873 A1
(43) Pub. Date: Apr. 2, 2009

(54) APPARATUS AND METHOD FOR THERMAL MANAGEMENT OF ELECTRONIC DEVICES

(75) Inventors: WILLIAM AVERY, AUSTIN, TX (US); CHARLES MC BRYDE, AUSTIN, TX (US)

Correspondence Address: AKERMAN SENTERFITT, P.O. BOX 3188, WEST PALM BEACH, FL, 33402-3188, US

(73) Assignee: AT&T KNOWLEDGE VENTURES, L.P., RENO, NV (US)

(21) Appl. No.: 11/862,812

(22) Filed: Sep. 27, 2007

(51) Int. Cl. G05B 13/02

(52) U.S. Cl. 700/51

(57) ABSTRACT

A system that incorporates teachings of the present disclosure may include, for example, a thermal management device having a controller to monitor pressure parameters for hot and cold rooms where the hot and cold rooms are divided by a rack for electronic devices and are substantially isolated from each other, and adjust a flow of cooling air to the cold room where the adjustment of the flow of cooling air to the cold room is based at least in part on the pressure parameters and maintaining a target pressure differential between the hot and cold rooms and where the target pressure differential induces a flow of the cooling air through one or more electronic devices in the rack. Other embodiments are disclosed.

### FIELD OF THE DISCLOSURE

The present disclosure relates generally to computer systems and more specifically to an apparatus and method for thermal management of electronic devices.

### BACKGROUND

Computer systems can often use a large number of servers that are positioned in a server rack in close proximity to each other. Each of the servers generates its own heat. As more servers are required for a system, they are often packed into denser configurations, which can significantly increase the thermal load. Servers can be separated from each other to alleviate some of the overall thermal load, but this increases floor space. Additionally, where not all of the servers are being fully utilized at one time, there can be significant fluctuation of thermal loads generated.

### BRIEF DESCRIPTION OF THE DRAWINGS

FIG. 1 depicts an exemplary embodiment of a server rack;

FIG. 2 depicts an exemplary block diagram of one of several embodiments for a thermal management system for the server rack of FIG. 1;

FIG. 3 depicts an exemplary method operating in portions of the thermal management system; and

FIG. 4 is a diagrammatic representation of a machine in the form of a computer system within which a set of instructions, when executed, may cause the machine to perform any one or more of the methodologies discussed herein.

### DETAILED DESCRIPTION

In one embodiment of the present disclosure, a computer-readable storage medium can have computer instructions for monitoring pressure and temperature parameters for hot and cold rooms where the hot and cold rooms are divided by a rack of servers and are substantially isolated from each other, determine a target frequency for one or more variable frequency drive (VFD) fans supplying cooling air to the cold room where the target frequency is based at least in part on the pressure parameters and maintaining a target pressure differential between the hot and cold rooms and where the target pressure differential induces flow of the cooling air through one or more servers in the rack of servers, and determining a target discharge temperature for one or more air conditioning units supplying the cooling air to the one or more VFD fans where the target discharge temperature is based at least in part on the temperature parameters and maintaining a target temperature for the one or more servers in the rack of servers.

In another embodiment of the present disclosure, a thermal management device can have a controller to monitor pressure parameters for hot and cold rooms where the hot and cold rooms are divided by a rack for electronic devices and are substantially isolated from each other, and adjust a flow of cooling air to the cold room where the adjustment of the flow of cooling air to the cold room is based at least in part on the pressure parameters and maintaining a target pressure differential between the hot and cold rooms and where the target pressure differential induces a flow of the cooling air through one or more electronic devices in the rack.

In another embodiment of the present disclosure, a method can involve determining a pressure differential between hot and cold rooms where the hot and cold rooms are divided by a rack for electronic devices and are substantially isolated from each other, adjusting a flow of cooling air to the cold room where the adjusting of the flow of cooling air to the cold room is based at least in part on the pressure differential and maintaining a target pressure differential between the hot and cold rooms, and providing cooling channels in proximity to one or more electronic devices in the rack where the pressure differential induces a flow of the cooling air through the cooling channels to cool the one or more electronic devices in the rack.

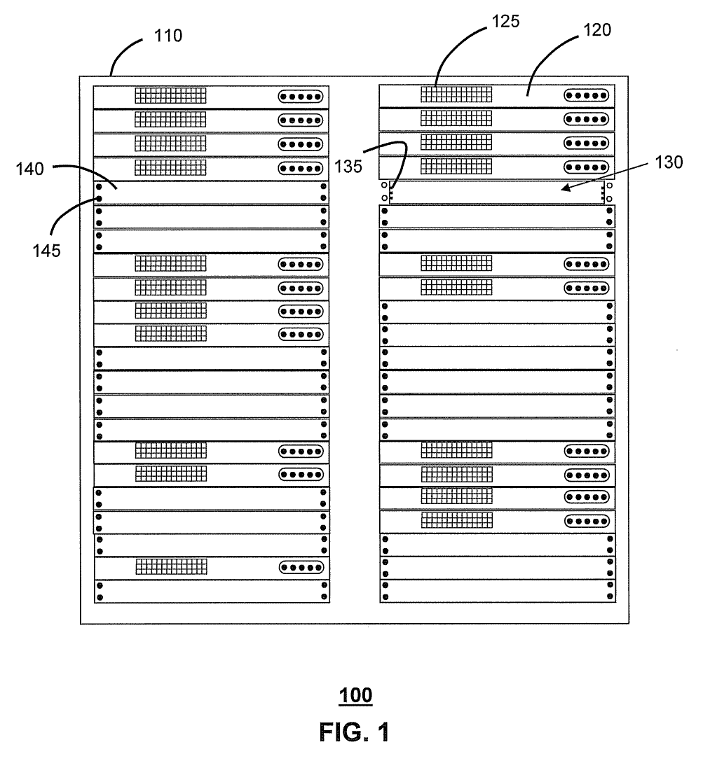

FIG. 1 depicts an exemplary embodiment of a server rack 100 for housing one or more servers 120. The servers 120 can be any type of modular computing component, including blade servers and 1RU servers. It should be understood by one of ordinary skill in the art that the servers 120 can include other computing or electronic devices, including routers. The server rack 100 can comprise a housing 110 or other structure for positioning the servers and providing them with support. In one embodiment, the housing 110 can define rows and columns of openings 130, only one of which is shown in FIG. 1. The rows and columns of the housing 110 can be substantially uniform. However, the particular configuration of the rows and columns or the configuration of the openings 130 can vary depending on a number of factors, including the uniformity of size of the servers 120, the amount of heat generated by the servers, and the size and/or weight of the servers.

The servers 120 can be positioned and supported within the openings 130 by various structure and techniques, including side rails 135 along the housing 110 that allow the servers to be slid in and out of the openings or otherwise mounted along a side portion thereof. In one embodiment, one or more of the columns of openings 130 can define larger openings (e.g., a single opening) so that servers having different heights can be housed in the rack 100 (e.g., a server utilizing two or more openings 130).

Server rack 100 can also include blanking plates 140 that can be connected with the rack to block any openings 130 that are not filled with the servers 120. The plates 140 can be secured to the housing 110 of the rack 100 by various structure and techniques, including fasteners 145. As will be described later in greater detail, the blanking plates 140 can prevent the flow of cooling air around the servers 120 so that the flow can be applied directly to the servers, such as through vents 125 of the servers. In one embodiment, the connection between the plates 140 and the housing 110 is not completely sealed and some air leakage can occur around the plates. In another embodiment, the connection between the plates 140 and the housing 110 can be sealed by various structure and techniques, including a gasket or a tight connection.

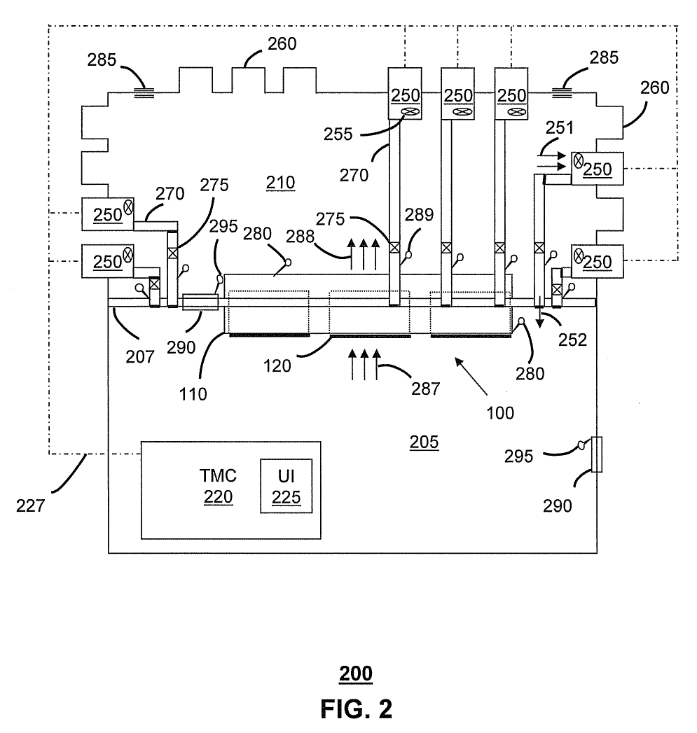

FIG. 2 depicts an exemplary embodiment of a thermal management system 200 that can be used to maintain a desired temperature or temperature range with respect to the servers 120 of the server rack 100. System 200 can comprise cold room or area 205 and a hot room or area 210 that are separated and substantially isolated from each other by the server rack 100 and a wall 207. The wall 207 can be built around the server rack 100 and/or the rack can be fitted into an opening made in the wall that is sized and shaped to sealingly receive the rack.

The thermal management system 200 can comprise a thermal management controller 220 that is operably connected to, and in communication with, one or more air conditioning (AC) units 250. The controller 220 can include a communications interface that utilizes common technology for communicating with the AC units 250, as well as other components of the thermal management system 200. The controller 220 can also include a memory (such as a high capacity storage medium), and a processor that makes use of computing technology such as a desktop computer, or scalable server for controlling operations of the thermal management system 200.

The controller 220 can have a user interface 225, such as a keypad with depressible or touch sensitive navigation disk and keys for manipulating operations of the controller, as well as a display such as monochrome or color LCD (Liquid Crystal Display) for conveying images to a technician or user of the thermal management system 200. The controller 220 can utilize computing technologies such as a microprocessor and/or digital signal processor (DSP) with associated storage memory such a Flash, ROM, RAM, SRAM, DRAM or other like technologies for controlling operations of the aforementioned components of the thermal management system 200.

The controller 220 can be connected to each of the AC units 250 by a wireline 227 and/or can be communicatively coupled by wireless technology. For example, the controller 220 and the AC units 250 can utilize common technologies to support singly or in combination any number of wireless access technologies including without limitation cordless phone technology (e.g., DECT), Bluetooth™, Wireless Fidelity (WiFi), Worldwide Interoperability for Microwave Access (WiMAX), Ultra Wide Band (UWB), software defined radio (SDR), RF and cellular access technologies such as CDMA-1X, W-CDMA/HSDPA, UMTS, GSM/GPRS, TDMA/EDGE, and EVDO. In another embodiment, a combination of wired and wireless connections can be used, such as for establishing redundancy in the event of a failure.

One or more of the AC units 250 can be positioned and/or supported in the hot area 210 by housings or casings 260. The particular number, configuration and/or positioning of the AC units 250 can vary depending on a number of factors, including the amount of servers 120 and the thermal load being generated. In one embodiment, the thermal management system 200 can provide for a modular thermal management process by allowing for the addition of more AC units 250 as the thermal load is increased (e.g., as more servers 120 are added to the server rack 100). For example, the casings 260 can have power connections, control connections, ductwork and so forth so that an AC unit 250 can be installed therein (e.g., received by the casing). While the exemplary embodiment shows the casings 260 as being positioned in the walls that define the hot area 210, the present disclosure contemplates the positioning and/or the configuration of the casings 260 varying, including free-standing in the hot area. In one embodiment, the AC units 250 can be chilled water units. In another embodiment, the AC units 250 can be vapor-compression cycle cooling systems. However, the present disclosure contemplates the use of other cooling systems, including in combination with the AC units 250, such as thermoelectric devices. Other components, such as heat exchangers can be utilized by thermal management system 200 to achieve a desired temperature in one or both of the cold and hot areas 205, 210.

Ductwork or supply channels 270 can be provided from the AC units 250 (or the casings 260) to the cold area 205 to supply the cooling area thereto. Each of the supply channels 270 can have a back flow damper 275 or other flow control device to provide for one-way flow of air through the channel, such as when one of the AC units 250 is turned off. The backflow dampers 275 can also help to direct air flow and/or reduce turbulence, such as changing the airflow from horizontal to vertical in the cold area 205. Air intake from the hot area 210 by one of the AC units 250 is shown by arrows 251, while the cooling air discharged into the cold area 205 is shown by arrow 252.

The cold and hot areas 205, 210 can be maintained at a differential pressure in order to induce flow from the cold area 205 through the servers 120 (e.g., through server vents 125) and into the hot area 210, as represented by arrows 287, 288. The thermal management system 200 can operate at various temperatures for the cold and hot areas 205, 210, as well as various differential pressures between the two. For example, the hot area 210 can operate at a temperature of 85° F. and the cold area 205 can operate at a temperature of 65° F., with a differential pressure between the cold and hot area of 0.006 inches water column. However, other operating conditions can be used that can provide even greater operating efficiencies. The differential pressure, where the cold area 205 has a higher pressure than the hot area 210, can induce flow of the cooling air from the cold area to the hot area through each of the servers 120. As described above, the use of the dampers 275 can prevent backflow of the cooling air through the supply channel that could occur where an AC unit 250 is not providing cooling air. The higher return air temperature of 85° F. can allow each of the AC units 250 to operate in a more efficient range.

The AC units 250 can have variable frequency drive (VFD) fans 255. The VFD fans 255 can control the rotational speed of an alternating current electric motor rotating the fan blades by controlling the frequency of the electrical power supplied to the motor. The VFD fans 255 can be continuously adjusted, such as by the controller 220, in response to various data provided to the controller to maintain the differential pressure between the hot and cold areas 205, 210. The present disclosure also contemplates other control devices to maintain the pressure differential by adjusting the VFD fans 255, including controllers of the AC units 250. Controlling the fan speed can reduce the amount of electricity required for the VFD fan 255 by requiring that the fan only supply the air that is required to maintain the differential pressure and allowing for fans to run at less than full speed which can significantly decrease power requirements.

The VFD fans 255 can be provided with enough capacity to maintain the desired pressure differential between the cold and hot areas 205, 210 even when there are exposed openings 130 through the server rack 100 (e.g., one or more blanking plates 140 have not been positioned over the openings 130). This can provide for sufficient cooling of the servers 120 even during server installations, removals, reconfigurations, repairs and so forth. One or more pressure sensors 280, such as pressure transducers, can be positioned in each of the cold and hot areas 205, 210 to provide data to the controller 220 for maintaining the desired pressure differential between the two areas. The pressure sensors 280 can be hardwired to the controller 220, such as through use of wireline 227 and/or can wirelessly transmit pressure data to the controller.

One or more vents 285 in communication with ambient or other air can be provided for the hot area 210 to maintain air quality and/or introduce humidity into the hot area, such as through supplying outdoor air. This can keep the air in the cold and hot areas 205, 210 from drying out and creating an adverse static electricity problem. In one embodiment, the ambient air can be ducted into the hot area 210 through the vents 285.

One or more temperature sensors 289, such as temperature transducers, can be positioned in each of the supply channels 270 to monitor for the discharge temperature of the cooling air. The present disclosure also contemplates the temperature sensors being positioned elsewhere, such as in other areas in the cold and hot areas 205, 210 to measure ambient room temperatures. The temperature sensors 289 can be hardwired to the controller 220, such as through use of wireline 227, and/or can wirelessly transmit temperature data to the controller.

Door open detectors 295 can be installed on the doors 290 to the cold and hot areas 205, 210. These detectors 295 can generate and transmit a signal, such as to the controller 220, for locking the VFD frequency set-point of the VFD fans 255 to their current setting while either door 290 is open. This can keep the VFD from speeding up the fans 255 when a door 290 is opened. For example, a first door 290 can be positioned in the wall 207 between the cold area 205 and hot area 210, while a second door 290 is positioned between the cold area 205 and the rest of the facility or to atmosphere. In one embodiment, the door 290 can be provided without latching hardware so as to function as a barometric fail safe in the event that the differential pressure is not properly controlled by the controller 220. However, the present disclosure also contemplates other configurations of the doors 290, as well as other pressure control devices and techniques being utilized.

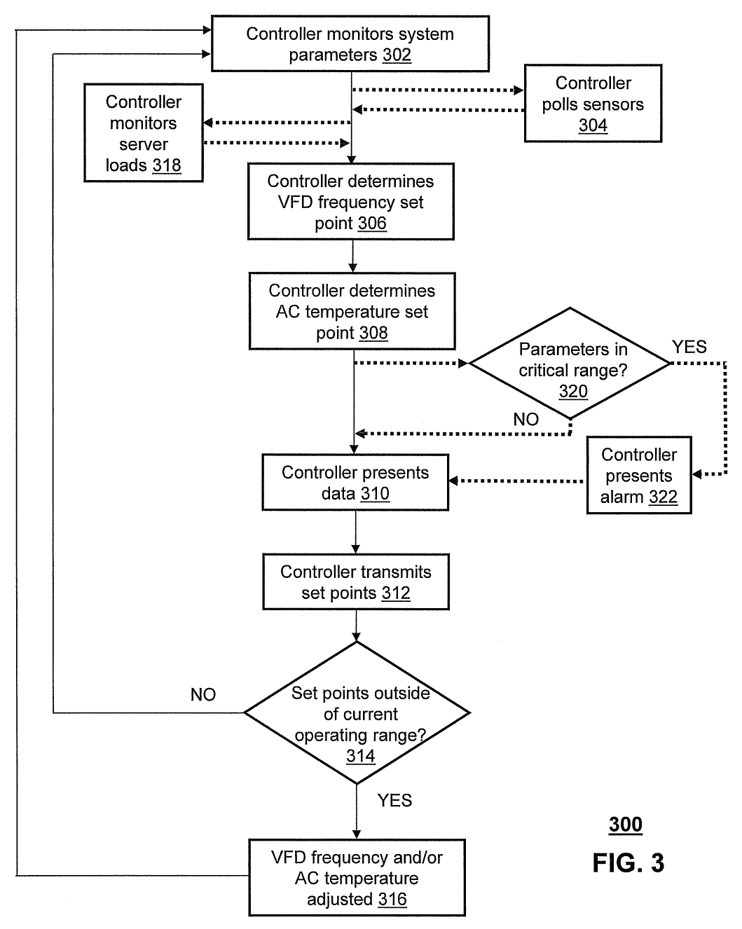

FIG. 3 depicts an exemplary method 300 operating in portions of the thermal management system 200. Method 300 has variants as depicted by the dashed lines. It would be apparent to an artisan with ordinary skill in the art that other embodiments not depicted in FIG. 3 are possible without departing from the scope of the claims described below.

Method 300 begins with step 302 in which the controller 220 can monitor for system parameters. The system parameters can vary and can come from a variety of sources, including the pressure and temperature sensors 280, 289, the AC units 250, and the VFD fans 255. For example, the controller 220 can obtain data with respect to the cold area temperature, hot area temperature, AC supply air temperature, AC supply air temperature set-points, VFD frequency, VFD percent, VFD current, AC chilled water valve open percent, pressure differential between cold area 205 and hot area 210, pressure differential set-point, voltage to servers 120, current to servers, and door open contacts (e.g., detectors 295).

In one embodiment in step 304 the controller 220 can poll the one or more data sources, such as sending a polling signal to each of the AC units 250 and/or sensors 280, 289 at a fixed or adjustable interval to retrieve the corresponding data. In another embodiment, the data sources can provide the corresponding data at scheduled intervals. The particular length of the interval and whether it is adjustable can vary. For instance, a shortened data retrieving interval may be used for a thermal load of the sensors 120 that fluctuates frequently. In one embodiment, the controller 220 can monitor the fluctuation of the thermal load or other system parameters, and can adjust the interval for data retrieval and/or implementation of control interval based on the monitoring.

In step 306, the controller 220 can determine the VFD frequency set point for each of the VFD fans 255. This determination can be based on the monitored pressure differential between the cold and hot areas 205, 210 and the pressure differential set point setting. In step 308, the controller 220 can determine the AC temperature set point for each of the AC units 250. This determination can be based on the monitored temperature of the cold area 205 and the cold area temperature set point setting.

The controller 220 can present the data or a portion of the data in step 310. The data can be presented in real-time. The data can be presented in various forms, such as graphs and the like, and can be manipulated data including providing historical information associated with the data. For example, particular time periods that have had historically higher thermal loads can be presented to the technician through UI 225 in combination with presenting the current thermal load. In step 312, the controller 220 can transmit the set points to the AC units 250 and the VFD fans 255.

In step 314, the AC units 250 and/or the VFD fans 255 (e.g., controllers associated with each of these components) can determine if the received set points are outside of a current operating range. If the set points are not outside of the current operating range of the AC units 250 and/or the VFD fans 255 then method 300 can return to step 302 to continue monitoring the system parameters. If on the other hand, the set points are outside of the current operating range of the AC units 250 and/or the VFD fans 255 then in step 316 the AC units 250 and/or the VFD fans 255 can adjust their respective discharge temperatures and VFD frequencies, and return to monitoring of the system parameters. The determination of whether the set points are outside of the operating range, as opposed to determining if the set points are different from the operating points, can include determining whether the current settings are within the deadband factor which could induce limit cycling.

In one embodiment in step 318, the controller 220 can monitor for server loads. The server loads can be used to predict changes to the amount of heat generated by the servers 120. This information can be used for adjusting the discharge temperatures and VFD frequencies of the AC units 250 and/or the VFD fans 255, respectively. In another embodiment in step 320, the controller 220 can determine whether any of the monitored parameters are in a critical range. If the parameters are not in a critical range then the controller 220 can present the data in a typical fashion (e.g., at a display monitor of UI 225), but if the parameters are in a critical range then in step 322 the controller 220 can present an alarm to a technician. For example, the controller 220 can monitor for the temperature in the cold area 205 and if the cold area goes more than 5° F. above a desired temperature then an alarm can be provided, such as a page to the technician.

Upon reviewing the aforementioned embodiments, it would be evident to an artisan with ordinary skill in the art that said embodiments can be modified, reduced, or enhanced without departing from the scope and spirit of the claims described below. For example, the configuration of the hot and cold areas 205, 210 can be varied, such as having a single hot area centrally positioned with respect to a plurality of surrounding cold areas. This configuration would allow for more server racks 100 to be cooled within a smaller envelope of space, as well as providing for centralized control for the server racks. Pressure relief components can be incorporated into the cold area 205, such as safety valves in the walls. In one embodiment, the doors 290 can be the pressure relief components that will open or unseal when an undesired pressure is reached in the cold area 205.

The thermal management system 200 can control the pressure differential between the cold and hot areas 205, 210 through use of other components and techniques. For example, flow control valves can be provided to bypass some of the discharge area (e.g., back into the hot area) to adjust the pressure differential or other adjustable speed drive fans can be used, such as DC drives or Eddy current drives. In one embodiment, separate pressure sources can be used to maintain or assist in maintaining the pressure differential. Other configurations for achieving the desired temperature and achieving the desired pressure differential can also be used by the thermal management system 200. For example, a plurality of AC units 250 can feed the cooling air to a single or a different number of VFD fans 255 that maintain the pressure differential.

These are but a few examples of modifications that can be applied to the present disclosure without departing from the scope of the claims. Accordingly, the reader is directed to the claims section for a fuller understanding of the breadth and scope of the present disclosure.

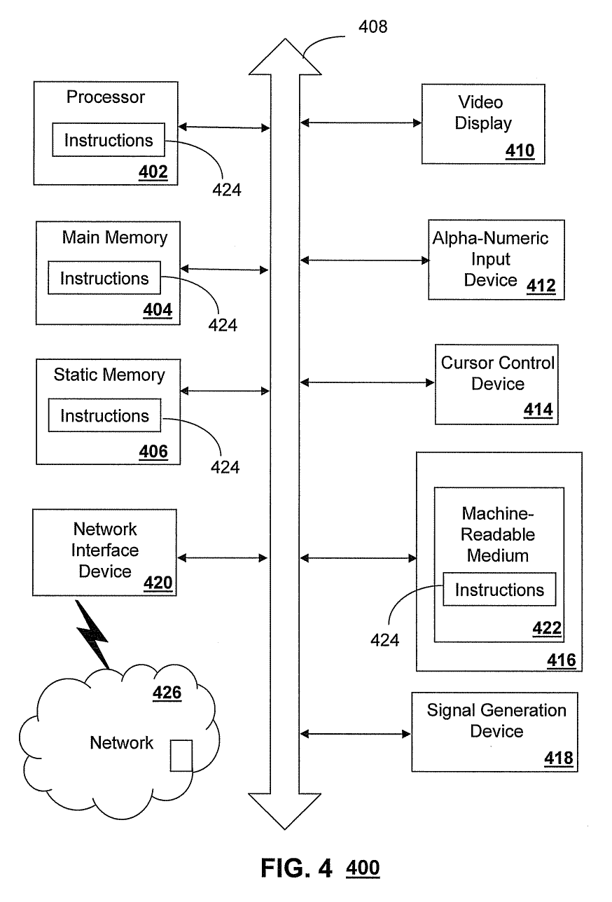

FIG. 4 depicts an exemplary diagrammatic representation of a machine in the form of a computer system 400 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 400 may include a processor 402 (e.g., a central processing unit (CPU), a graphics processing unit (GPU, or both), a main memory 404 and a static memory 406, which communicate with each other via a bus 408. The computer system 400 may further include a video display unit 410 (e.g., a liquid crystal display (LCD), a flat panel, a solid state display, or a cathode ray tube (CRT)). The computer system 400 may include an input device 412 (e.g., a keyboard), a cursor control device 414 (e.g., a mouse), a mass storage medium 416, a signal generation device 418 (e.g., a speaker or remote control) and a network interface device 420.

The mass storage medium 416 may include a computer-readable storage medium 422 on which is stored one or more sets of instructions (e.g., software 424) embodying any one or more of the methodologies or functions described herein, including those methods illustrated above. The computer-readable storage medium 422 can be an electromechanical medium such as a common disk drive, or a mass storage medium with no moving parts such as Flash or like non-volatile memories. The instructions 424 may also reside, completely or at least partially, within the main memory 404, the static memory 406, and/or within the processor 402 during execution thereof by the computer system 400. The main memory 404 and the processor 402 also may constitute computer-readable storage media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 424, or that which receives and executes instructions 424 from a propagated signal so that a device connected to a network environment 426 can send or receive voice, video or data, and to communicate over the network 426 using the instructions 424. The instructions 424 may further be transmitted or received over a network 426 via the network interface device 420.

While the computer-readable storage medium 422 is shown in an example embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure.

The term “computer-readable storage medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a computer-readable storage medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computer-readable storage medium, comprising computer instructions for:
monitoring pressure and temperature parameters for hot and cold rooms, the hot and cold rooms being divided by a rack of servers and being substantially isolated from each other;
determining a target frequency for one or more variable frequency drive (VFD) fans supplying cooling air to the cold room, the target frequency being based at least in part on the pressure parameters and maintaining a target pressure differential between the hot and cold rooms, the target pressure differential inducing flow of the cooling air through one or more servers in the rack of servers; and
determining a target discharge temperature for one or more air conditioning units supplying the cooling air to the one or more VFD fans, the target discharge temperature being based at least in part on the temperature parameters and maintaining a target temperature for the one or more servers in the rack of servers.

2. The storage medium of claim 1, comprising computer instructions for at least one of:
adjusting a current frequency for the one or more VFD fans based on the target frequency; and
adjusting a current discharge temperature for the one or more air conditioning units based on the target discharge temperature.

3. The storage medium of claim 2, comprising computer instructions for presenting data associated with the monitoring of the pressure and temperature parameters.

4. The storage medium of claim 1, comprising computer instructions for presenting an alarm when at least one of the pressure and temperature parameters is within a critical range.

5. The storage medium of claim 1, comprising computer instructions for obtaining information associated with at least one among a VFD percent, a VFD current, a chilled water valve open percent for the air conditioning unit, voltage to the one or more servers, and current to the one or more servers.

6. A thermal management device, comprising a controller to:
monitor pressure parameters for hot and cold rooms, the hot and cold rooms being divided by a rack for electronic devices and being substantially isolated from each other; and
adjust a flow of cooling air to the cold room, the adjustment of the flow of cooling air to the cold room being based at least in part on the pressure parameters and maintaining a target pressure differential between the hot and cold rooms, the target pressure differential inducing a flow of the cooling air through one or more electronic devices in the rack.

7. The device of claim 6, wherein the controller is adapted to:
monitor temperature parameters for the cold room;
determine a target discharge temperature for one or more air conditioning units supplying the cooling air to the cold room, the target discharge temperature being based at least in part on the temperature parameters and maintaining a target temperature for the one or more electronic devices in the rack; and
adjust a current discharge temperature for the one or more air conditioning units based on the target discharge temperature.

8. The device of claim 6, wherein the controller is adapted to:
determine a target frequency for one or more variable frequency drive (VFD) fans that adjust the flow of cooling air to the cold room, the target frequency being based at least in part on the pressure parameters and maintaining the target pressure differential between the hot and cold rooms; and
adjust a current frequency for the one or more VFD fans based on the target frequency.

9. The device of claim 7, wherein the controller is adapted to present data associated with the monitoring of the pressure and temperature parameters.

10. The device of claim 7, wherein the controller is adapted to present an alarm when at least one of the pressure and temperature parameters is within a critical range.

11. The device of claim 8, wherein the controller is adapted to obtain information associated with at least one among a VFD percent, a VFD current, a chilled water valve open percent for the air conditioning unit, voltage to the one or more electronic devices, and current to the one or more electronic devices.

12. The device of claim 6, wherein the electronic devices are servers.

13. A method comprising:
determining a pressure differential between hot and cold rooms, the hot and cold rooms being divided by a rack for electronic devices and being substantially isolated from each other;
adjusting a flow of cooling air to the cold room, the adjusting of the flow of cooling air to the cold room being based at least in part on the pressure differential and maintaining a target pressure differential between the hot and cold rooms; and
providing cooling channels in proximity to one or more electronic devices in the rack, wherein the pressure differential induces a flow of the cooling air through the cooling channels to cool the one or more electronic devices in the rack.

14. The method of claim 13, comprising receiving pressure data from one or more pressure sensors positioned in the cold room.

15. The method of claim 14, comprising receiving the pressure data at an adjustable interval.

16. The method of claim 13, comprising:
monitoring temperature parameters for the cold room;
determining a target discharge temperature for one or more air conditioning units supplying the cooling air to the cold room, the target discharge temperature being based at least in part on the temperature parameters and maintaining a target temperature for the one or more electronic devices in the rack; and
adjusting a current discharge temperature for the one or more air conditioning units based on the target discharge temperature.

17. The method of claim 16, comprising receiving temperature data associated with the temperature parameters at an adjustable interval.

18. The method of claim 13, comprising:
determining a target frequency for one or more variable frequency drive (VFD) fans that adjust the flow of cooling air to the cold room, the target frequency being based at least in part on the pressure differential and maintaining the target pressure differential between the hot and cold rooms; and
adjusting a current frequency for the one or more VFD fans based on the target frequency.

19. The method of claim 16, comprising presenting data associated with the monitoring of the pressure differential and the temperature parameters.

20. The method of claim 16, comprising presenting an alarm when at least one of the pressure differential and the temperature parameters is within a critical range.

21. The method of claim 18, comprising obtaining information associated with at least one among a VFD percent, a VFD current, a chilled water valve open percent for the air conditioning unit, voltage to the one or more electronic devices, and current to the one or more electronic devices.

22. The method of claim 21, comprising obtaining the information at an adjustable interval.

23. The method of claim 13, wherein the electronic devices are servers.
